(19) United States
(12) Patent Application Publication
(10) Pub. No.: US 2026/0296480 A1
(43) Pub. Date: Oct. 1, 2026

(54) Autonomous driving vehicle and control method therefor

(71) Applicants: Hyundai Motor Company, Seoul (KR); Kia Corporation, Seoul (KR)

(72) Inventors: Han Young CHOI, Hwaseong-Si (KR); Young Bin MIN, Hwaseong-Si (KR); Jong Sung PARK, Hwaseong-Si (KR); Moon Hyung SONG, Cheonan-si (KR)

(21) Appl. No.: 19/379,127

(22) Filed: Nov. 4, 2025

(30) Foreign Application Priority Data
Mar. 31, 2025 (KR) 10-2025-0041249

(51) Int. Cl. B60W 50/16; B60W 50/02; B60W 50/029; B60W 60/00; B60W 50/14

(52) U.S. Cl. CPC B60W 50/16; B60W 50/0205; B60W 50/029; B60W 60/0053; B60W 60/0059; B60W 2050/0292; B60W 2050/143; B60W 2050/146; B60W 2556/40

(57) ABSTRACT

An autonomous driving vehicle and a control method are disclosed. A method performed by an apparatus of a vehicle may include: monitoring, based on an autonomous driving feature of the vehicle being activated, a state of the vehicle and a surrounding environment of the vehicle; determining, based on the state of the vehicle and the surrounding environment, whether the vehicle is expected to depart from an operational design domain associated with the autonomous driving feature; based on determining that the vehicle is expected to depart from the operational design domain, determining information about the operational design domain; and outputting, via a user interface of the vehicle, the information. The information may include at least one of: a departure time at which the vehicle is expected to depart from the operational design domain, or a departure position at which the vehicle is expected to depart from the operational design domain.

### CROSS-REFERENCE TO RELATED APPLICATION

This application claims priority to and the benefit of Korean Patent Application No. 10-2025-0041249, filed in the Korean Intellectual Property Office on Mar. 31, 2025, the disclosure of which is incorporated herein by reference in its entirety.

### TECHNICAL FIELD

The present disclosure relates to an autonomous driving vehicle and a control method therefor.

### BACKGROUND

Advanced driver assistance systems (ADAS) have been developed to assist drivers in driving. The ADAS is also called autonomous driving and is also called autonomous driving system (ADS).

Unlike autonomous driving on general roads (e.g., city roads), highway (e.g., freeway, expressway, etc.) autonomous driving may have unique features. Because there are no intersections, traffic lights, or pedestrians on highways, the vehicle flow may be relatively constant and the predictability of the road conditions may be relatively high compared to those of non-highway roads.

The highway can be a favorable environment in which various autonomous driving technologies may be utilized, such as a lane keeping assist system (LKAS) that controls the vehicle to maintain a lane being traveled, adaptive cruise control (ACC) that maintains a distance from a vehicle ahead and automatically (e.g., adaptively) adjust the speed of the vehicle, and an automatic lane change system (ALCS) that automatically changes lanes according to real-time road conditions.

An autonomous driving vehicle needs to be informed about whether the current operational design domain (ODD) is satisfied and whether there is a possibility of departing from the operational design domain. Whether the operational design domain is satisfied, and the possibility of departing therefrom, may vary depending on the state of the vehicle and the surrounding environment of the vehicle. Therefore, there is a need for a method of better communicating, to an occupant of the vehicle, information related to the operation design domain.

The description described in this section is provided merely as background information for the present disclosure and does not constitute prior art.

### SUMMARY

Accordingly, the present disclosure is intended to solve these problems, and a main object of the present disclosure is to provide a method of providing information related to an operational design domain differently to an occupant according to a state of a vehicle and a surrounding environment of the vehicle.

The problems to be solved by the disclosure are not limited to the above-mentioned problems, and other problems that are not mentioned will be clearly understood by those skilled in the art from the following description.

According to one or more example embodiments of the present disclosure, a method performed by an apparatus of a vehicle may include: monitoring, based on an autonomous driving feature of the vehicle being activated, a state of the vehicle and a surrounding environment of the vehicle; determining, based on the state of the vehicle and the surrounding environment, whether the vehicle is expected to depart from an operational design domain associated with the autonomous driving feature; based on determining that the vehicle is expected to depart from the operational design domain, determining information about the operational design domain; and outputting, via a user interface of the vehicle, the information. The information may include at least one of: a departure time at which the vehicle is expected to depart from the operational design domain, or a departure position at which the vehicle is expected to depart from the operational design domain.

Outputting the information may include: based on whether the vehicle is expected to depart from the operational design domain in a future time period, the departure time, and the departure position, outputting different pieces of information associated with the expected departure from the operational design domain.

Outputting the information may include: based on the vehicle being expected to depart from the operational design domain and the departure time being at least a first threshold time duration after a current time or based on the departure position being at least a first threshold distance away from a current position of the vehicle, outputting first operational design domain information including a cause of departure from the operational design domain and a state of the autonomous driving feature at the departure time.

Outputting the information may further include: outputting second operational design domain information, based on the vehicle being expected to depart from the operational design domain and based on at least one of: the departure time being within the first threshold time duration from the current time; the departure position being within the first threshold distance from the current position of the vehicle; a second threshold time duration having elapsed since the outputting of the first operational design domain information; or a second threshold distance being traveled by the vehicle since the outputting of the first operational design domain information. The second operational design domain information may include state information, at the departure time, of a sub function or a component associated with the autonomous driving feature. The second threshold distance may be less than the first threshold distance. The second threshold time duration is less than the first threshold time duration.

Outputting the information may further include: outputting third operational design domain information, based on the vehicle being expected to depart from the operational design domain and based on at least one of: the departure time being within a third threshold time duration from the current time; the departure position being within a third threshold distance from the current position of the vehicle; a fourth threshold time duration having elapsed since the outputting of the second operational design domain information; or a fourth threshold distance being traveled by the vehicle since the outputting of the second operational design domain information. The third operational design domain information may include at least one of: the cause of departure from the operational design domain, numerical information regarding the cause of departure, and numerical information regarding the state of the autonomous driving feature at the departure time.

The method may further include: performing, based on a dynamic driving task (DDT) not being detected within a threshold time duration after the vehicle departs from the operational design domain, a minimal risk maneuver (MRM) to stop the vehicle.

The method may further include: transferring, based on the vehicle being expected to depart from the operational design domain, vehicle control from the vehicle to an occupant of the vehicle.

The method may further include: reactivating, based on the vehicle entering the operational design domain, the autonomous driving feature.

The method may further include: determining, based on sensing data of at least one sensor of the vehicle, the state of the vehicle and the surrounding environment of the vehicle; and identifying at least one event, associated with an expected departure from the operational design domain, that is expected to occur within a predetermined time period from a reference time. Determining whether the vehicle is expected to depart from the operational design domain may be further based on map data associated with a driving path of the vehicle.

According to one or more example embodiments of the present disclosure, a vehicle may include: a human-machine interface (HMI) configured to output at least one of a visual signal, a tactile signal, or an auditory signal to provide information to an occupant of the vehicle; a sensor configured to monitor, based on an autonomous driving feature of the vehicle being activated, a state of the vehicle and a surrounding environment of the vehicle; a processor; and a memory storing at least one instruction. The at least one instruction may be configured, when executed by the processor communicating with the memory, to cause the vehicle to: determine, based on the state of the vehicle and the surrounding environment, whether the vehicle is expected to depart from an operational design domain associated with the autonomous driving feature; based on determining that the vehicle is expected to depart from the operational design domain, determine information about the operational design domain; and output, via the HMI, the information. The information may include at least one of: a departure time at which the vehicle is expected to depart from the operational design domain, or a departure position at which the vehicle is expected to depart from the operational design domain.

The at least one instruction may be configured, when executed by the processor communicating with the memory, to cause the vehicle to output the information by: based on whether the vehicle is expected to depart from the operational design domain in a future time period, the departure time, and the departure position, output, via the HMI, different pieces of information associated with the expected departure from the operational design domain.

The at least one instruction may be configured, when executed by the processor communicating with the memory, to cause the vehicle to output the information by: based on the vehicle being expected to depart from the operational design domain and the departure time being at least a first threshold time duration after a current time or based on the departure position being at least a first threshold distance away from a current position of the vehicle, outputting first operational design domain information including a cause of departure from the operational design domain and a state of the autonomous driving feature at the departure time.

The at least one instruction may be configured, when executed by the processor communicating with the memory, to cause the vehicle to output the information further by: outputting second operational design domain information, based on the vehicle being expected to depart from the operational design domain and based on at least one of: the departure time being within the first threshold time duration from the current time; the departure position being within the first threshold distance from the current position of the vehicle; a second threshold time duration having elapsed since the outputting of the first operational design domain information; or a second threshold distance being traveled by the vehicle since the outputting of the first operational design domain information. The second operational design domain information may include state information, at the departure time, of a sub function and a component associated with the autonomous driving feature. The second threshold distance may be less than the first threshold distance. The second threshold time duration may be less than the first threshold time duration.

The at least one instruction may be configured, when executed by the processor communicating with the memory, to cause the vehicle to output the information further by: outputting third operational design domain information, based on the vehicle being expected to depart from the operational design domain and based on at least one of: the departure time being within a third threshold time duration from the current time; the departure position being within a third threshold distance from the current position of the vehicle; a fourth threshold time duration having elapsed since the outputting of the second operational design domain information; or a fourth threshold distance being traveled by the vehicle since the outputting of the second operational design domain information. The third operational design domain information may include at least one of: the cause of departure from the operational design domain, numerical information regarding the cause of departure, and numerical information regarding the state of the autonomous driving feature at the departure time.

The at least one instruction may be configured, when executed by the processor communicating with the memory, to further cause the vehicle to: perform, based on a dynamic driving task (DDT) not being detected within a threshold time duration after the vehicle departs from the operational design domain, a minimal risk maneuver (MRM) to stop the vehicle.

The at least one instruction may be configured, when executed by the processor communicating with the memory, to further cause the vehicle to: transfer, based on the vehicle being expected to depart from the operational design domain, vehicle control from the vehicle to the occupant.

The at least one instruction may be configured, when executed by the processor communicating with the memory, to further cause the vehicle to: reactivate, based on the vehicle entering the operational design domain, the autonomous driving feature.

The at least one instruction may be configured, when executed by the processor communicating with the memory, to further cause the vehicle to: determine, based on sensing data of at least one sensor of the vehicle, the state of the vehicle and the surrounding environment of the vehicle; identify at least one event, associated with an expected departure from the operational design domain, that is expected to occur within a predetermined time period from a reference time; and determine that the vehicle is expected to depart from the operational design domain based on: map data associated with a driving path of the vehicle, the state of the vehicle, and the surrounding environment.

As described above, according to the present disclosure, it is possible to provide a method of providing information related to the operational design domain differently to the occupant according to the state of the vehicle and/or the surrounding environment of the vehicle.

In addition, it is possible to determine whether the vehicle is expected to depart from the operational design domain in the future (e.g., before a reference time, such as within 10 seconds), and when it is determined that the vehicle is expected to depart therefrom, to determine at least one of a departure time and a departure position.

In addition, it is possible to provide information related to the operational design domain variably to the occupant according to whether the vehicle is expected to depart from the operational design domain, the departure time, and the departure position.

### BRIEF DESCRIPTION OF THE DRAWINGS

FIG. 1 is a functional block diagram of a vehicle.

FIG. 2 is a flowchart illustrating an example method of controlling a vehicle.

FIG. 3 is a flowchart illustrating an example method of controlling a vehicle as a state of the vehicle or a surrounding environment of the vehicle changes.

FIG. 4 is a diagram for describing control of a vehicle driving on a highway.

FIG. 5 is a schematic diagram of an example operational design domain.

FIG. 6 is a flowchart illustrating an example method of controlling a vehicle when departure from the operational design domain is expected.

FIG. 7 is a block diagram schematically illustrating an example vehicle system.

### DETAILED DESCRIPTION

Hereinafter, one or more example embodiments of the disclosure will be described in detail with reference to drawings. In assigning reference numerals to the components of each drawing, it should be noted that the same numerals are used for the same components, as much as possible, even if they are shown in different drawings. In addition, in describing the disclosure, if it is determined that a specific description of a related known configuration or function may obscure the gist of the disclosure, the detailed description thereof will be omitted.

In describing the components of the disclosure, the terms “first,” “second,” “A,” “B,” “(a),” “(b),” and the like may be used. These terms are only used to distinguish the components from other components, and the nature, sequence, order, or the like of the components is not limited by these terms. For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

When a component is described as being “connected,” “coupled,” or “connected” to other component, it should be understood that the component may be directly connected or connected to the other component, but another component may also be “connected,” “connected,” or “coupled” between each component.

Throughout the specification, when a part is referred to as "including" or "comprising" a component, it means that, unless specifically stated otherwise, the part may further include other components instead of excluding the other components.

The terms such as "unit" and "module" described in the specification mean a unit that processes at least one function or operation, and may be implemented by hardware or software, or a combination of hardware and software.

Unless otherwise stated, it should be understood that the description of any one example embodiment may be applied to other example embodiment(s) as well.

The description to be disclosed below in connection with the accompanying drawings is intended to describe one or more example embodiments of the disclosure and is not intended to represent the only embodiments in which the disclosure may be practiced.

The terms used in the present disclosure may be defined as follows.

The vehicle is a vehicle equipped with an automated driving system (ADS) and capable of autonomous driving. For example, the vehicle may perform at least one of steering, acceleration, deceleration, lane change, braking, and stopping without operation of the driver by the ADS. The ADS may include, for example, at least one of a Pedestrian Detection and Collision Mitigation System (PDCMS), a Lane Change Decision Aid System (LCDAS), a Land Departure Warning System (LDWS), Adaptive Cruise Control (ACC), a Lane Keeping Assistance System (LKAS), a Road Boundary Departure Prevention System (RBDPS), a Curve Speed Warning System (CSWS), a Forward Vehicle Collision Warning System (FVCWS), and Low Speed Following (LSF).

The occupant, the user, and the driver are all human beings who use the vehicle and are provided with services of the autonomous driving system.

The vehicle control authority or vehicle control right refers to the authority to control at least one component of the vehicle and/or at least one function of the vehicle. The functions of the vehicle may include at least one of the steering function, the acceleration function, the deceleration function, the braking function, the lane change function, the line detection function, the lateral control function, the object (or obstacle) recognition and distance detection function, the powertrain control function, a safe area detection function, the engine on/off function, the power on/off function, and the vehicle lock/unlock function. The listed vehicle functions are merely examples for facilitating understanding, and the present disclosure is not limited thereto.

The lane refers to an area of a road on which a vehicle travels, and means a space divided so that the vehicle travels in a single line. A current lane refers to a lane in which the vehicle is traveling in real time. For example, when the vehicle is traveling in lane 2, the current lane for the vehicle is lane 2.

An adjacent lane means a lane that abuts the current lane. For example, for a road including a plurality of lanes, when the current lane is lane 1, the adjacent lane may be lane 2. For example, if the current lane is lane 2, the adjacent lanes may be lane 1 and lane 3.

Entire lanes means lane 1 to the outermost lane. For example, for a road that includes three lanes, the entire lanes may be lane 1, lane 2, and lane 3.

A line means a line that separates different lanes. For example, in a case where there are four lanes and four lanes, line 1 divides areas of lane 1 and lane 2, line 2 divides areas of lane 2 and lane 3, line 3 divides areas of lane 3 and lane 4, and line 4 divides areas of lane 4 and a shoulder.

The shoulder means a road located at the edge of a road. The shoulder is a road configured to allow the vehicle to stop in the event of an emergency situation, or to allow emergency vehicles such as ambulances or police cars to travel quickly. The shoulder in the present disclosure may be used as a concept including a safety zone such as a rest area, a pocket lane, and a preset area.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., monitoring and management of operational design domains) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., monitoring and management of operational design domains) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., monitoring and management of operational design domains) described herein.

Minimum risk maneuver (MRM) operation(s) may also be controlled, for example, based on one or more features (e.g., monitoring and management of operational design domains) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., monitoring and management of operational design domains) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., monitoring and management of operational design domains) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., monitoring and management of operational design domains) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging (e.g., activating) and/or disengaging (e.g., deactivating) an autonomous driving mode, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

A Dynamic Driving Task (DDT) may refer to a concept including all tasks required during driving. The dynamic driving task may be a concept including not only a physical operation such as steering, acceleration, and deceleration of the vehicle, but also a cognitive task and a judgmental task such as a task of detecting and understanding a surrounding environment of the vehicle, a driving path planning, and traffic rule compliance. The dynamic driving task (DDT) may refer to a concept including tasks of recognizing, in real time, the state of the vehicle, the surrounding environment of the vehicle, the state of the road and the like and responding appropriately thereto.

Depending on the autonomous driving level and mode, the range of dynamic driving tasks (DDT) assigned between the human driver and the autonomous driving system is different.

In the case of the autonomous driving levels 1 to 4, even when the autonomous driving system operates, performance and intervention of the dynamic driving task (DDT) by the human driver are required. For example, in the case of autonomous driving level 2, the autonomous driving system performs acceleration, deceleration, and steering, but the driver is still required to monitor and intervene in the entire dynamic driving task (DDT).

In the case of the autonomous driving level 5, the autonomous driving system performs all dynamic driving tasks (DDT), and intervention by the driver is unnecessary.

The operational design domain (ODD) may refer to operating conditions that are specifically designed (or set) for the autonomous driving system to operate. For example, an ODD may define the operating conditions under which a vehicle’s one or more automated driving features can be safely engaged (e.g., activated). The operational design domain may refer to a concept including various conditions required for performing autonomous driving functions, such as surrounding environment during driving, weather conditions, time zone, traffic conditions, road characteristics, vehicle speed, and whether the vehicle functions are operating normally.

If the states for the vehicle 100 and/or the surrounding environment of the vehicle 100 do not satisfy the conditions of the operational design domain, all or part of the functions of the autonomous driving may be restricted (e.g., disengaged or suspended).

An example in which the vehicle 100 has departed from the operational design domain or does not satisfy the operation design domain will be described. A vehicle departing from or leaving the operational design domain may mean that the vehicle no longer satisfies conditions that are required to start (e.g., engage or activate) an autonomous driving feature or keep the feature engaged.

The case in which the vehicle has departed from the operational design domain may mean any case in which the vehicle is unable to perform autonomous driving due to an internal cause and/or an external cause of the vehicle.

The case in which the vehicle has departed from the operational design domain may mean any case in which at least one of various functions of the vehicle may not be performed, any case in which at least one of the functions related to driving of the vehicle may not be performed, any case in which the driving of the vehicle itself is not possible, due to the internal cause and/or the external cause of the vehicle, and the like.

For example, the case in which the vehicle has departed from the operational design domain may mean a case in which a malfunction occurs in at least one of various functions of the vehicle. For example, it may mean a case in which a malfunction occurs in at least one of the steering function, the acceleration function, the deceleration function, the braking function, a stopping function, the lane change function, a lane and line detection function, the lateral control function, the object (or obstacle) recognition and distance detection function, a current position measurement function, the powertrain control function, the safe area detection function, the engine on/off function, the power on/off function, the vehicle lock/unlock function, a communication function, and the autonomous driving function.

For example, when the surrounding environment of the vehicle changes while the operational design domain is satisfied during driving, the vehicle may depart from the operational design domain. For example, it may means a situation in which object recognition using sensors is not possible or sensor operation is difficult to operate normally, due to weather conditions (e.g., heavy rain, heavy snow, dense fog, backlight, air temperature), in which a road is damaged or is in an abnormal state due to a sinkhole or natural disaster (e.g., landslide, flooding), in which driving along a general path is impossible due to a large-scale accident or an obstacle on the road, in which the road is slippery to the extent that it is difficult to drive and/or brake (e.g., icy road, wet road), and in which the number of drivable lanes is reduced or needs to be bypassed due to road construction, and the like.

For example, when the operational design domain is not satisfied, a Minimal Risk Maneuver (MRM) may be performed. The minimal risk maneuver may mean a vehicle operation method for minimizing the occurrence of an accident, such as performing a lane change or stopping the vehicle. In any cases where normal autonomous driving may not be performed, the minimal risk maneuver for the vehicle may be performed. When a problem occurs in one or more of the functions for performing autonomous driving, the minimal risk maneuver may be performed. When the vehicle suddenly departs from the operational design domain while performing autonomous driving, the minimal risk maneuver may be performed. The definition of the minimal risk maneuver and the situation in which the minimal risk maneuver is performed are not limited to the examples described above.

The foregoing descriptions are merely examples, and the description related to the operational design domain according to the present disclosure is not limited by the foregoing descriptions.

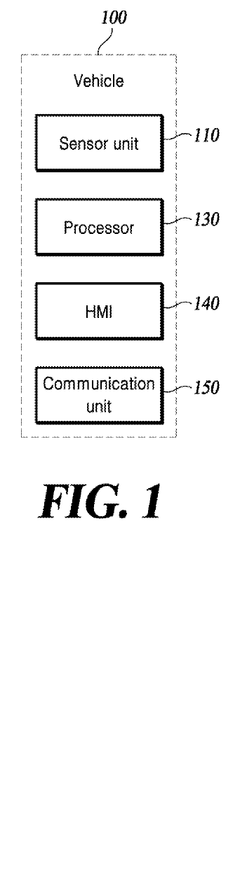

FIG. 1 is a functional block diagram of a vehicle.

Referring to FIG. 1, a vehicle 100 according to the present disclosure may include a sensor unit (also referred to as a sensor) 110, a processor 130, a human-machine interface (HMI, also referred to as a user interface) 140, a communication unit 150, a memory (not shown), and the like. Components that vehicle 100 according to the present disclosure may include are not limited by FIG. 1. It is also possible to further include other components not disclosed in FIG. 1.

The vehicle 100 according to the present disclosure may perform autonomous driving using the autonomous driving system.

The vehicle 100 according to the present disclosure may autonomously determine a state of the vehicle and a state of the surrounding environment of the vehicle and automatically set a mode of autonomous driving, thereby providing a good user experience for autonomous driving.

The vehicle 100 according to the present disclosure may change the mode of autonomous driving according to a user's request. The user may use the HMI 140 to change the mode of autonomous driving of the vehicle 100.

The vehicle 100 according to the present disclosure may monitor, in real time, the vehicle 100 and the surrounding environment of the vehicle.

The vehicle 100 according to the present disclosure may determine, in real time, the state of the vehicle 100 and the surrounding environment of the vehicle based on the monitoring data.

The vehicle 100 according to the present disclosure may variably perform a guidance operation to the occupant according to the determined state.

The vehicle 100 according to the present disclosure may variably set the mode of autonomous driving according to the determined state. For example, when the vehicle 100 and/or the surrounding environment of the vehicle 100 does not satisfy or has departed from the operational design domain, the vehicle 100 may set the autonomous driving mode to the fallback mode.

The sensor unit 110 includes at least one sensor. The sensor unit 110 may generate data for respective components of the vehicle by using at least one sensor. The data for the respective components of the vehicle collected by the sensor unit 110 and the data generated by the respective components of the vehicle themselves are collectively defined as vehicle data.

The vehicle data may include data related to vehicle speed, acceleration, steering angle, temperature of brake pads, wear level of brake pads, engine RPM, remaining fuel amount, coolant temperature, tire inflation pressure, engine oil state, battery voltage, interior/exterior temperature of the vehicle cabin, current position of the vehicle, transmission temperature, and the like. The vehicle data according to the present disclosure is not limited by the above-described examples. The processor 130 may determine the state of the vehicle based on the collected vehicle data. That is, the processor 130 may determine whether each component of the vehicle is normal and whether there is a mechanical/electronic failure, and the like.

The sensor unit 110 may detect the surrounding environment of the vehicle by using at least one sensor, and generate sensing data for the surrounding environment of the vehicle (hereinafter, “surrounding sensing data”).

The processor 130 may determine the surrounding environment and surrounding situation of the vehicle based on the collected surrounding sensing data. For example, the processor 130 may analyze the surrounding sensing data to determine weather conditions (heavy rain, heavy snow, dense fog, backlight, air temperature, etc.), road conditions (sinkholes, road cracks, black ice, wet road, etc.), whether a traffic accident has occurred, whether there is a traffic jam, etc.

The processor 130 may obtain information on object around the vehicle, for example, other vehicle, people, object, curb, guardrail, lane, line, obstacle, or the like based on the surrounding sensing data. The information on the object around the vehicle may include at least one of a position of the object, a size of the object, shape of the object, distance to the object, and relative speed to the object.

The surrounding sensing data according to the present disclosure is not limited by the example described above.

The processor 130 may determine, in real time, whether the vehicle 100 satisfies the operational design domain based on the vehicle data and/or the surrounding sensing data.

The processor 130 may control the HMI 140 to variably provide information related to the operational design domain to the occupant according to whether the vehicle 100 is expected to depart from the operational design domain, a departure time (e.g., a time at which the vehicle is expected to depart from the operational design domain), and a departure position (e.g., a vehicle position or vehicle location at which the vehicle is expected to depart from the operational design domain).

The sensor unit 110 may include a camera, a light detection and ranging (LIDAR), a radar, an ultrasonic sensor, an infrared sensor, a position measurement sensor, and the like. The listed sensors are merely examples for facilitating understanding, and the sensor of the present disclosure is not limited thereto.

The at least one camera may capture the vehicle interior. The camera may capture a user inside the vehicle to generate user photograph data. The type of the camera is not limited. For example, the camera may be an optical camera, a thermal camera, an infrared camera, or the like.

The processor 130 may determine, based on the user capture data, whether the user is in a situation capable of performing driving. The processor 130 may set the mode of autonomous driving based on the user capture data. The processor 130 may perform control to change or maintain the mode of autonomous driving based on the user capture data.

The camera may capture the surroundings of the vehicle to generate data for objects located in front, back, and sides of the vehicle.

The LIDAR may generate data for objects located in front, back, and sides of the vehicle by using light (or a laser).

The radar may generate data for objects located in front, back, and sides of the vehicle by using electromagnetic waves (or radio waves).

The ultrasonic sensors may generate data for objects located in front, back, and sides of the vehicle by using ultrasonic waves. The infrared sensor may generate data for objects located in front, back, and sides of the vehicle by using infrared rays.

The sensor unit 110 may measure the current position of the vehicle by using the position measurement sensor. The sensor unit 110 may include a global positioning system (GPS) sensor, a differential global positioning system (DGPS) sensor, a global navigation satellite system (GNSS) sensor, and the like. The position data of the vehicle may be generated based on signals generated by position measurement sensors such as the GPS sensor, the DGPS sensor, and the GNSS sensor.

The vehicle 100 may obtain weather information on the surroundings of the vehicle by using the sensor unit 110. For example, the processor 130 may determine whether it is raining based on a signal from a rain sensor.

In the present disclosure, the monitoring data refer to a concept including the vehicle data and the surrounding sensing data described above. That is, the processor 130 of the vehicle 100 may determine, in real time, a state of the vehicle 100 and/or the surrounding environment of the vehicle 100 based on the monitoring data.

The processor 130 may control respective components of the vehicle. The processor 130 may control the sensor unit 110, the HMI 140, the communication unit 150, and the like. The processor 130 may control the respective components of the vehicle to perform the steering function, the acceleration function, the deceleration function, the braking function, the lane change function, the line detection function, the lateral control function, the object (obstacle) recognition and distance detection function, the powertrain control function, the safe area detection function, and the like.

The processor 130 may control autonomous driving of the vehicle. The processor 130 may determine whether there is a malfunction in function required for autonomous driving. The functions required for autonomous driving may include, for example, the line detection function, the lane change function, the lateral control function, the deceleration (or brake control) function, the powertrain control function, the safe area detection function, and the object (obstacle) recognition and distance detection function.

The processor 130 may determine whether a malfunction has occurred in each component based on signals received from respective components of the vehicle 100 or signals received from the sensor unit 110. That is, the processor 130 may determine whether a malfunction has occurred in each component of the vehicle 100 based on the monitoring data.

The processor 130 may set the mode of autonomous driving. The processor 130 may perform control to maintain or change the mode of autonomous driving. For example, the processor 130 may change the adaptive cruise control (ACC) mode to the lane keeping assist (LKA) mode. The processor 130 may perform control to change a level of autonomous driving. For example, the processor 130 may change a mode of autonomous driving of level 1 to a mode of autonomous driving of level 2.

The HMI 140 may include a display, a speaker, a haptic device (e.g., a steering wheel, a seat, a button, a touchscreen), an input mean, and the like. The HMI 140 in the present disclosure refers to an interface configured to allow the occupant and the vehicle 100 to interact with each other.

The HMI 140 may provide various information to the occupant using visual, auditory, and tactile signals. For example, the HMI 140 may provide information such as vehicle speed, start/end of autonomous driving, transfer of control right, change of autonomous driving mode, real-time driving path, surrounding traffic situation, warning sound output, weather, lane change start/end and the like. The components that HMI 140 according to the present disclosure may include and the functions that HMI 140 may perform are not limited by the examples listed above.

The occupant may input a command to control the vehicle using the HMI 140. For example, the occupant may input a command to control the vehicle using button, touchscreen, voice recognition function, or the like of the HMI 140.

The input means of the HMI 140 may include button, touchscreen, microphone for voice recognition function, and the like. The user may set the autonomous driving mode using the input means of the HMI 140.

The HMI 140 may guide the user, using visual, auditory, and tactile signals, as to whether the autonomous driving mode is set, maintained, or changed. The HMI 140 may inform the user that the autonomous mode has been changed automatically or manually.

When the mode in which the autonomous driving level is 2 is changed to the mode in which an autonomous driving level is 3, the HMI 140 may guide the user with information on a section capable of traveling to the autonomous driving level 3. For example, the HMI 140 may guide the user with visual and/or auditory signals with content such as “Autonomous driving at level 3 will continue for 3 km from the current position.”

When the user has manually requested the mode change, but the mode change is not possible, the HMI 140 may guide the user that the mode change is not possible. When the mode is automatically changed without the request from the user, the HMI 140 may guide the user that the mode has been changed. When the driver does not immediately perform the dynamic driving task even though the dynamic driving task (DDT) of the driver is expected to increase soon or the dynamic driving task has already increased, the HMI 140 may output the warning sound to raise the user's alertness.

The display may indicate an entire path that is a path to a final destination. The display may indicate a path for performing autonomous driving among the entire path. The display may indicate the level of autonomous driving being performed.

The communication unit 150 supports vehicle-to-everything (V2X) communication, and may communicate with an external device of the vehicle 100 under the control of the processor 130. The communication unit 150 may perform communication using a wireless communication protocol or a wired communication protocol.

The memory stores map data. The map data may be road-related data or a high-definition map. For example, the map data may be data on a road slope, a road width, a road length, a road curvature, or a variation in road curvature. The processor 130 may determine whether a specific road satisfies the operational design domain based on the pre-stored map data.

The vehicle 100 may perform autonomous driving in various modes. The vehicle 100 may autonomously or manually change the mode of autonomous driving. The vehicle 100 may perform modes such as a standby mode, adaptive cruise control mode (hereinafter, “ACC mode”), lane keeping assist mode (hereinafter, “LKA mode”), highway driving assist mode (hereinafter, “HDA mode”), highway driving assist mode with lane change function activated (HDA Mode with Lane Change Function Activated, hereinafter, “HDA w/LC mode”), highway driving pilot mode (hereinafter, “HDP mode”), and highway driving pilot mode with lane change function activated (HDP Mode with Lane Change Function Activated, hereinafter, “HDP w/LC mode”). The above-listed modes are merely examples for description. The types of modes that may be performed by the vehicle 100 according to the present disclosure are not limited by the above-listed modes.

In the standby mode, the vehicle waits in a state where it is ready to perform autonomous driving control.

The ACC mode and the LKA mode are each a mode in which the autonomous driving level is 1. The ACC mode is a longitudinal control mode that controls the longitudinal behavior of the vehicle. The ACC mode is a mode in which the distance from the vehicle in front is automatically adjusted, and the speed of the vehicle is adjusted in accordance with the speed set by the driver.

The LKA mode is a lateral control mode that controls the lateral behavior of the vehicle. The LKA mode is a mode that assists the vehicle to maintain the current lane.

The HDA mode and the HDA w/LC mode are each a mode in which the autonomous driving level is 2. In the case of the mode in which the autonomous driving level is 2, the driver has a duty to look ahead. When the lane change function is activated, the vehicle 100 may autonomously determine whether to perform a lane change. When the lane change function is activated, the vehicle may autonomously perform the lane change to an adjacent lane.

The HDA mode is a longitudinal and lateral control mode. In the HDA mode, the vehicle 100 may autonomously control both longitudinal behavior and lateral behavior simultaneously. In the HDA mode, the vehicle does not perform the lane change.

The HDA w/LC mode is a mode in which the lane change function is added to the HDA mode. The HDA w/LC mode is the longitudinal and lateral control mode with the lane change function activated. The HDA w/LC mode may control both longitudinal behavior and lateral behavior of the vehicle simultaneously. In the HDA w/LC mode, the vehicle may autonomously perform the lane change.

The HDP mode and the HDP w/LC mode are each a mode with the autonomous driving level of 3. In the case of the mode in which the autonomous driving level is 3, the driver is not obliged to look ahead.

The HDP mode is the longitudinal and lateral control mode. In the HDP mode, the vehicle 100 may autonomously control both longitudinal behavior and lateral behavior simultaneously. In the HDP mode, the vehicle does not perform the lane change.

The HDP w/LC mode is a mode in which the lane change function is added to the HDP mode. The HDP w/LC mode is the longitudinal and lateral control mode with the lane change function activated. The HDP w/LC mode may control both longitudinal behavior and lateral behavior of the vehicle simultaneously. In the HDP w/LC mode, the vehicle may autonomously perform the lane change.

The mode of autonomous driving of the vehicle 100 may be changed by an input from the user. The mode of autonomous driving of the vehicle 100 may be automatically changed according to the determination by the processor 130.

It is also possible for the level of autonomous driving to be configured such that only sequential changes are possible, when the mode is changed manually by the input from the user, or when the mode is automatically changed according to the determination by the processor 130. For example, in the case of a mode in which the autonomous driving level is 1, the mode may not be changed to the mode in which the level is 3 at a time. In order to change from the autonomous driving mode with the level 1 to the mode with the level 3, it is necessary to change from the mode with the levels 1 to the modes with the levels 2, and from the mode with levels 2 to the mode with levels 3. When only a sequential change is possible, it is possible to prevent confusion of the driver due to a sudden change in the autonomous driving level.

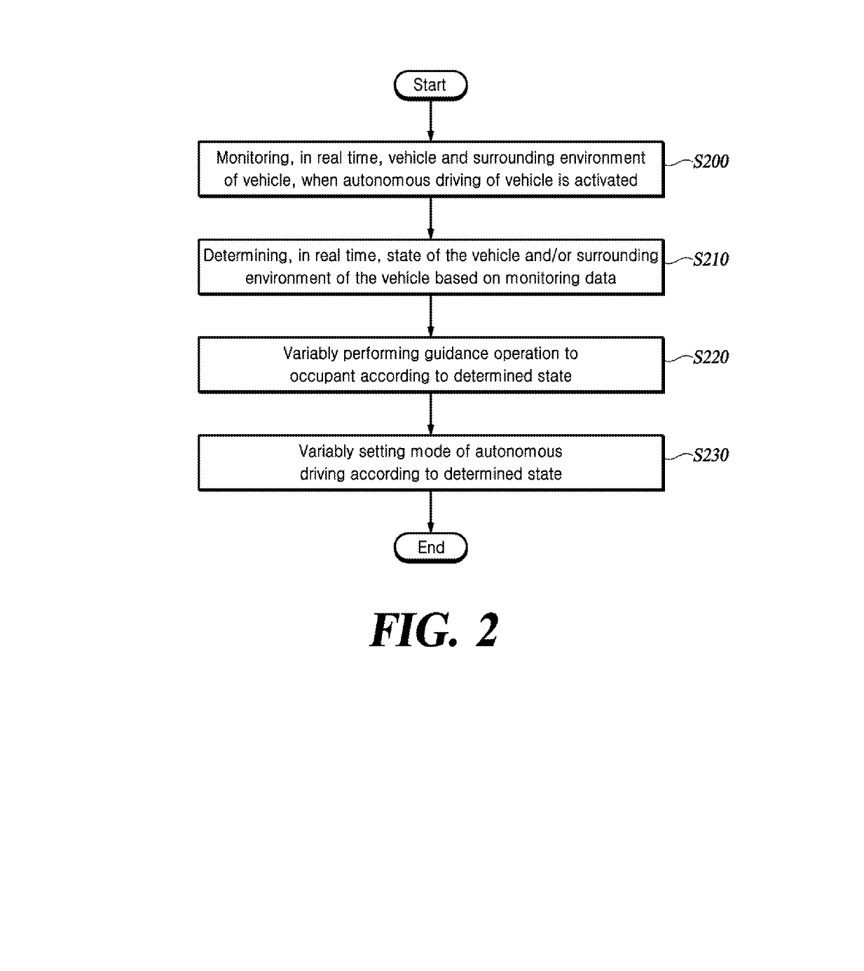

FIG. 2 is a flowchart illustrating an example method of controlling a vehicle.

Steps S200 to S230 of FIG. 2 will be described.

Step S200 will be described. When the autonomous driving is activated, the vehicle 100 may monitor, in real time, the vehicle 100 and the surrounding environment of the vehicle 100, and generate monitoring data. The monitoring data is a concept including the vehicle data and the surrounding sensing data described above. The processor 130 may control the sensor unit 110 and respective components of the vehicle 100 to monitor the vehicle 100 and the surrounding environment of the vehicle 100, and generate monitoring data.

Step S210 will be described. The processor 130 of the vehicle 100 may determine, in real time, the state of the vehicle 100 and/or the surrounding environment of the vehicle 100 based on the monitoring data.

The state of the vehicle 100 and/or the surroundings of the vehicle 100 will be described. The state of the vehicle 100 and/or the surrounding environment of the vehicle 100 (hereinafter, “vehicle and/or surrounding state”) may include an undetected state for a boundary of operational design domain (ODD boundary) (hereinafter, “undetected state”), a detected state for the boundary of operational design domain (hereinafter, “detected state”), an approaching state for the boundary of operational design domain (hereinafter, “approaching state”), an adjacent state for the boundary of operational design domain (hereinafter, “adjacent state”), a departure state for the boundary of operational design domain (hereinafter, “departure state”), and the like.

The boundary of operational design domain will be described. In the present disclosure, the term boundary of operational design domain is used to determine whether the vehicle and/or surrounding state has a relatively high or low possibility of departing from the operational design domain. The closer the vehicle and/or surrounding state is to the boundary of operational design domain, the higher the possibility of departure from the operational design domain becomes. When arranged in order from a relatively low to a relatively high possibility of departure from the boundary of operational design domain, the order is: the undetected state, the detected state, the approaching state, and the adjacent state. That is, when arranged in order of being close to the boundary of operational design domain, the order is: the adjacent state, the approaching state, the detected state, and the undetected state.

The departure state means a state in which the vehicle does not satisfy the operational design domain or has departed from the boundary of operational design domain. In the departure state, the vehicle 100 may not be able to perform most functions related to autonomous driving or may not be able to perform autonomous driving itself.

When the vehicle is in undetected state, the detected state, the approaching state, and the adjacent state, it is considered a non-departure state in which the vehicle has departed from the boundary of operational design domain. In the non-departure state, the vehicle 100 may perform all or some of the functions related to autonomous driving.

The vehicle and/or surrounding state may change in real time.

The vehicle and/or surrounding state may change in real time due to weather changes. For example, when heavy rain suddenly begins in clear weather, the processor 130 may determine, based on the monitoring data, whether lines or objects are recognizable. When the sensor unit 110 is unable to recognize lines, objects, and the like due to the heavy rain, the processor 130 may determine that autonomous driving is not possible. The processor 130 may determine that the vehicle and/or surrounding state has changed from the undetected state to the departure state due to the heavy rain. Conversely, when the heavy rain suddenly stops and the weather becomes clear, the processor 130 may determine that the vehicle and/or surrounding state has changed from the departure state to the non-departure state.

The vehicle and/or surrounding state may change in real time due to changes in road conditions. For example, in a case where a rockfall suddenly occurs in a state where there is no obstacle in front of a road on which the vehicle is traveling, the processor 130 may determine, based on the monitoring data, whether passage is possible. When the vehicle 100 may not pass due to the rockfall, the processor 130 may determine that autonomous driving is not possible. The processor 130 may determine that the vehicle and/or surrounding state has changed from the undetected state to the departure state due to the rockfall.

The vehicle and/or surrounding state may change in real time due to a malfunction of the vehicle 100. For example, when a normal tire is suddenly damaged during driving and driving itself becomes impossible, the processor 130 may determine that the vehicle and/or surrounding state has changed from the undetected state to the departure state due to the tire damage.

When the vehicle 100 is driving on a highway, the vehicle and/or surrounding state may change in real time. For example, as the vehicle 100 approaches a highway exit during driving, the processor 130 may determine that the vehicle 100 is approaching the boundary of operational design domain.

As such, the processor 130 may determine, in real time, what state the vehicle and/or surrounding state is in, based on the monitoring data. The processor 130 may determine, in real time, whether the current vehicle and/or surrounding state corresponds to any one of the undetected state, the detected state, the approaching state, the adjacent state, and the departure state.

Step S220 will be described. According to the vehicle and/or the surrounding state determined in the above-described Step S210, the vehicle 100 may variably perform the guidance operation to the occupant (S220). The vehicle 100 may perform the guidance operation using the HMI 140 to deliver high-level attribute information, unit attribute information, and unit attribute numerical information to the occupant. The high-level attribute information, the unit attribute information, and the unit attribute numerical information is information related to whether the current operational design domain is satisfied, and specific examples of each will be described later.

The vehicle 100 according to the present disclosure may perform the guiding operation differently according to the vehicle and/or surrounding state, so that the occupant may intuitively recognize the degree of possibility of departure from the current operational design domain and which condition within the operational design domain has an issue.

When the determined vehicle and/or surrounding state is the detected state, the components of the vehicle 100, such as the HMI 140, may provide the high-level attribute information of the operational design domain under the control of the processor 130 (S220). The process of providing the high-level attribute information may include guiding the occupant regarding at least one or more of whether longitudinal behavior control among the functions of autonomous driving is possible, whether lateral behavior control is possible, whether lane change control is possible, whether the transfer of vehicle control right is required, and whether the change of the autonomous driving mode is required.

When providing the high-level attribute information, the vehicle 100 may provide the information using natural language. When the vehicle 100 provides the information using natural language, the occupant may intuitively understand the vehicle and/or surrounding state. The vehicle 100 may provide the high-level attribute information using a natural language-based image or voice.

When the vehicle 100 provides high-level attribute information in the detected state, the vehicle may provide the information using natural language, as in “Weather conditions are deteriorating. Some autonomous driving functions may be limited.” However, the vehicle may not specifically provide detailed information regarding which function is limited or to what extent the function is reduced quantitatively. This is because the detected state has a relatively lower possibility of departure from the boundary of operational design domain compared to the approaching state and the adjacent state. That is, as the possibility of departure from the boundary of operational design domain increases, the vehicle 100 may specifically provide more detailed information.

Several examples of providing the high-level attribute information using natural language in the detected state will be further described.

The vehicle 100 may provide guidance in a non-quantitative manner regarding how many meters of the road are left where autonomous driving is possible, as in “There is not much road left where autonomous driving is possible. Please prepare for the transfer of control right.” The vehicle 100 may also provide abstract guidance regarding the road surface condition, as in “Due to poor road surface conditions, lane departure may occur. The vehicle may stop abruptly.” The vehicle may not provide guidance using a specific numerical value indicating the percent likelihood of lane departure. As such, when providing high-level attribute information, the vehicle 100 may provide the information at an abstract level. This is because the detected state has a relatively lower possibility of departure from the boundary of operational design domain. When providing the high-level attribute information, the vehicle 100 does not use technical terms, but uses a term of a level used in daily life so that even a person without knowledge of autonomous driving technologies may intuitively understand the information.

When the determined vehicle and/or surrounding state is the approaching state, the components of the vehicle 100 such as the HMI 140 may provide unit attribute information of the operational design domain under the control of the processor 130 (S220).

When providing the unit attribute information, the vehicle 100 may provide the information using technical terms. The vehicle 100 may provide the unit attribute information using the natural language-based image or voice.

The vehicle 100 may not use technical terms when providing high-level attribute information, but may use technical terms when providing unit attribute information. When providing the unit attribute information, the vehicle 100 provides more specific information than when providing the high-level attribute information. This is because the approach state has a relatively higher possibility of departure from the boundary of operational design domain compared to the detected state.

Several examples of providing unit attribute information by utilizing technical terms in the approaching state will be described.

The vehicle 100 may provide unit attribute information using the technical term lateral control, as in “Weather conditions are deteriorating. There is a possibility that lateral control may be limited.” The vehicle 100 may provide unit attribute information using the technical term lateral control and the technical term minimal risk maneuver, as in “Due to icy road, there is a possibility that a problem may occur in the lateral control of autonomous driving. The minimal risk maneuver (MRM) is likely to be performed.” The vehicle 100 may provide unit attribute information using the technical term lateral control, as in “Lateral control is unstable due to rainfall.”

The process of providing the unit attribute information may be a process of providing at least one or more of static road environment factor, dynamic road environment factor, driving environment factor, and whether the functions of the vehicle 100 are operating normally.

The static road environment factor refer to a factor that affects the dynamic driving task (DDT), and refer to a concept including a physical structure of the road, a type of the line, the road boundary, the road attribute, or the like. The physical structure of the road may be classified into highway, arterial road, local road, curved road, intersection, tunnel, road entrance or exit, and the like. Examples of the types of line include a general line, a bus-only line, a left-turn line, a U-turn line, a passing line, and the like. The road boundary refers to a facility that divides or protects the road, and defines a space of the road. The road boundary includes guardrail, median strip, curb, grass strip, soundproof wall, railing, or the like. The attributes of the road mean traffic rules and legal standards applied to that road, such as speed limit, bus-only line, parking or stopping regulation, and the like.

When providing unit attribute information, the vehicle 100 may provide information related to the highway exit corresponding to the static road environment factor, as in “Autonomous driving is scheduled to end upon passing the highway exit. Please prepare for the transfer of vehicle control right.”

The dynamic road environment factor refers to a factor that affects the dynamic driving task. The dynamic road environment factor relates to road condition that change over time, and means a factor that directly affects real-time traffic flow and safety. The dynamic road environment factors include traffic signal information, surrounding traffic objects, traffic accident status, and the like. The traffic signal information may mean a change in the color of a traffic light, a flashing signal, a signal cycle, or the like. The surrounding traffic object refers to a concept including moving objects that use the road, such as passenger cars, special vehicles, motorcycles, and pedestrians. The traffic accident status refers to a concept including an accident occurrence position, a type of accident, road occupancy, whether passage is possible, and the like.

When providing unit attribute information, the vehicle 100 may provide information related to the traffic accident status corresponding to the dynamic road environment factor, as in “A traffic accident has occurred ahead, making it difficult to pass. Autonomous driving is scheduled to end, so please prepare for the transfer of vehicle control right.”

The driving environment factor refers to a factor that affects the dynamic driving task. The driving environment factor refers to an external environment factor that affects the road and the operation of the vehicle, and refers to factors that affect the securing the driver's field of view, the driving performance of the vehicle, and the road safety. The driving environment factors include weather, dust, brightness, driving visibility, and the like. The weather refers to a concept including weather conditions such as rainfall, snowfall, temperature, wind speed, wind direction, fog, and the like. The brightness means lighting environments such as day/night, tunnels, and street lamps. The driving visibility means visual elements that affect the dynamic driving task, such as fog, light reflection, glare, and the ability of sensors to detect the surroundings of the vehicle.

When providing unit attribute information, the vehicle 100 may provide information related to the driving visibility or weather corresponding to the driving environment factor, as in “Dense fog is present ahead, which degrades both the securing the field of view and the object recognition function using sensors. Autonomous driving is scheduled to end, so please prepare for the transfer of vehicle control right.” When providing unit attribute information, the vehicle 100 may use technical term such as the object recognition function using sensors.

Whether the functions of the vehicle 100 are operating normally refers to whether the behavior function, the object recognition function, the sensing function for a surrounding environment, and the like of the vehicle are operating normally. The object recognition function means a lane recognition function, a line recognition function, other vehicle recognition function, or the like, for a road on which the vehicle is traveling.

The behavior function of the vehicle means a longitudinal control function, a lateral control function, a vehicle posture control function, and the like.

When providing unit attribute information, the vehicle 100 may provide information regarding whether the function of the vehicle (lateral control function) is operating normally, as in “There is a possibility that a problem may occur in the lateral control of autonomous driving due to the wet road. The minimal risk maneuver (MRM) is likely to be performed.”

When the determined vehicle and/or surrounding state is the adjacent state, the component of the vehicle 100 such as the HMI 140 may provide numerical information (hereinafter, “unit numerical information”) on the unit attribute of the operational design domain under the control of the processor 130 (S220). That is, the process of providing the unit numeric information may be a process of providing the unit attribute information accompanied by numerical values using natural language. When providing the unit numerical information, the vehicle 100 provides more specific information than when providing the unit attribute information. This is because the adjacent state has a relatively higher likelihood of departure from the boundary of operational design domain than the approaching state. The process of providing the unit numerical information may be a process of providing a current error level with respect to an allowable error, a current value with respect to a safety value, a margin value for a safety coefficient, or the like. The unit numerical information may be provided as specific numbers or ratios so that the occupant may intuitively understand the information. The process of providing the unit numerical information may be a process of providing at least one or more of the line recognition error rate, the remaining distance to the highway exit, the time for transfer of the vehicle control right, and the error rate of the lateral behavior control for lane keeping.

Several examples of the case where the vehicle 100 provides the unit numerical information in the adjacent state will be described.

When providing the unit numerical information, the vehicle 100 may simultaneously provide unit attribute information (line recognition function), as in "Due to rainfall, the line recognition error rate is 5% or more. When the error is 10% or more, the autonomous driving is automatically terminated.”, and also provide specific numerical values (5%, 10%).

When providing the unit numerical information, the vehicle 100 may simultaneously provide unit attribute information (highway exit, static road environment factor), as in "500 meters remain until the highway exit. Autonomous driving will end in approximately 30 seconds. Please prepare for the transfer of vehicle control right,” and also provide specific numerical values (500 m, 30 seconds).

When providing the unit numerical information, the vehicle 100 may simultaneously provide unit attribute information (lateral control function), as in "An error of 3 degrees or more has occurred in the lateral control for lane keeping. If the error reaches 5 degrees or more, a minimal risk maneuver (MRM) may be performed,” and also provide specific numerical values (3 degrees, 5 degrees).

Step S230 will be described. The processor 130 of the vehicle 100 may variably set the mode of autonomous driving according to the vehicle and/or the surrounding state determined in step S210 (S230).

As illustrated in FIG. 2, step S230 may be performed after step S220 is performed. Unlike in FIG. 2, the step S220 and the step S230 may be performed simultaneously with each other. Unlike in FIG. 2, the step S220 may be performed after step S230 is performed.

In step S230, when the vehicle is in the non-departure state, the processor 130 may variably set the mode of autonomous driving according to the vehicle and/or surrounding state.

In step S230, when the vehicle is in the departure state, the processor 130 may set the autonomous driving mode to the fallback mode.

The fallback mode may be a mode performed in a situation in which it is difficult or impossible to normally perform autonomous driving. For example, when it is difficult to normally perform autonomous driving due to a sensor error, software conflict, or path recognition failure, the mode of the vehicle 100 may be set to the fallback mode.

In the fallback mode, the processor 130 may perform control for the vehicle 100 based on functions of autonomous driving, the level of autonomous driving, and the like that are applicable in the current state.

In the fallback mode, the vehicle control right may be transferred from the vehicle 100 to the occupant. That is, the processor 130 transfers the vehicle control right to the occupant.

In the fallback mode, the processor 130 may perform the minimal risk maneuver (MRM). In the fallback mode, the processor 130 may move the vehicle 100 to a safe area by utilizing limited functions of the sensors or vehicle 100. In the fallback mode, when neither the vehicle 100 nor the occupant is able to perform the dynamic driving task, the processor 130 may perform failure mitigation strategy control to stop the vehicle 100. The failure mitigation strategy refers to a concept that includes utilizing a redundancy system to continue driving or perform a safe stop procedure.

If the autonomous driving of the vehicle 100 is deactivated, if the vehicle and/or the surrounding state changes from the departure state to the non-departure state, the processor 130 may perform control to reactivate the autonomous driving. That is, even when the vehicle and/or the surrounding state changes from the non-departure state to the departure state and the autonomous driving of the vehicle 100 is deactivated, if the vehicle and/or the surrounding state return to the non-departure state again, the processor 130 may reactivate the autonomous driving of vehicle 100.

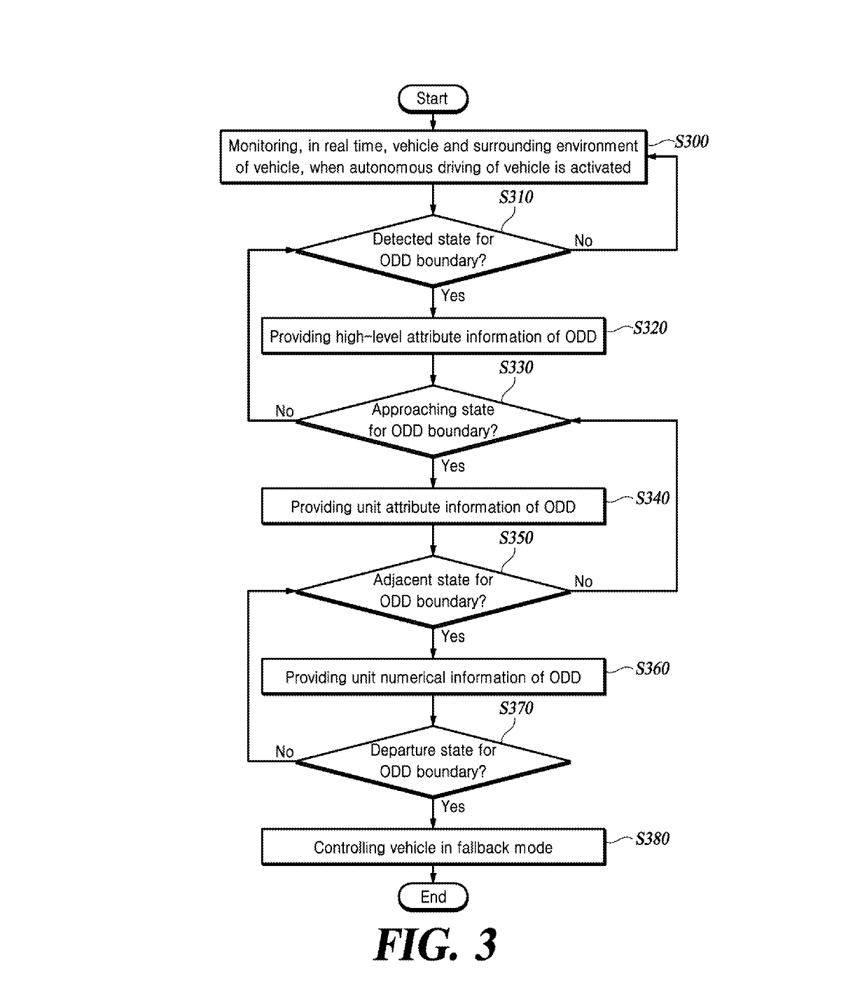

FIG. 3 is a flowchart illustrating an example method of controlling a vehicle performed as a state of the vehicle or a surrounding environment of the vehicle changes.

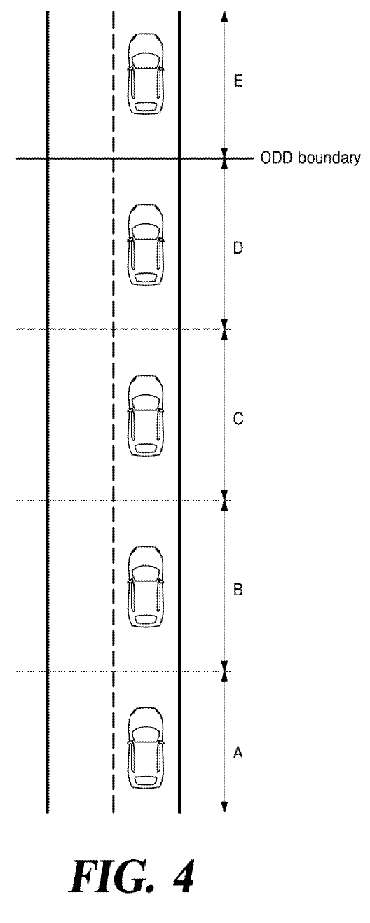

FIG. 4 is a diagram for describing control of a vehicle driving on a highway.

When the vehicle 100 is traveling on the highway, the vehicle and/or surrounding state may change in real time. For example, as the vehicle 100 while driving approaches an exit for leaving the highway, the vehicle and/or surrounding state is more likely to change from the non-departure state to the departure state.

Upon entering the exit for leaving the highway, the vehicle and/or surrounding state becomes the departure state, and the vehicle 100 is unable to perform highway autonomous driving, such as highway driving assist mode (HDA mode).

With reference to FIG. 3 and FIG. 4 in parallel, a control method of the vehicle according to a change in a vehicle and/or surrounding state will be described.

When the autonomous driving is activated, the vehicle 100 may monitor, in real time, the vehicle and the surrounding environment of the vehicle (S300). Based on monitoring data collected by the monitoring, the processor 130 may determine, in real time, the vehicle and/or surrounding state. Section A is further away from the highway exit than other sections illustrated in FIG. 4. When the vehicle 100 enters the highway exit, the processor 130 may determine that the vehicle has departed from the boundary of operational design domain (ODD boundary). When the vehicle 100 is located in the section A, the processor 130 determines that the vehicle and/or surrounding state corresponds to the undetected state.

In the undetected state, the processor 130 determines whether the vehicle and/or surrounding state has changed to the detected state (S310).

When the vehicle 100 enters a section B from the section A, the processor 130 determines that the vehicle and/or surrounding state corresponds to the detected state (S310, yes). In the detected state, the processor 130 may provide high-level attribute information of the operational design domain to the occupant (S320).

In the detected state, the processor 130 determines whether the vehicle and/or surrounding state has changed to the approaching state (S330).

When the vehicle enters a section C from the section B, the processor 130 determines that the vehicle and/or surrounding state corresponds to the approaching state (S330, yes). In the approaching state, the processor 130 may provide unit attribute information of the operational design domain to the occupant (S340).

In the approaching state, the processor 130 determines whether the vehicle and/or surrounding state has changed to the adjacent state (S350).

When the vehicle enters a section D from the section C, the processor 130 determines that the vehicle and/or surrounding state corresponds to the adjacent state (S350, yes). In the adjacent state, the processor 130 may provide unit numerical information of the operational design domain to the occupant (S360).

In the adjacent state, the processor 130 determines whether the vehicle and/or surrounding state has changed to the departure state (S370).

When the vehicle enters a section E from the section D, the processor 130 determines that the vehicle and/or surrounding state corresponds to the departure state (S370, yes). The section E is a section indicating the highway exit.

In the departure state, the processor 130 may control the vehicle 100 in the fallback mode (S380). In the fallback mode, the vehicle 100 may be stopped in a safe place by the minimal risk maneuver. In the fallback mode, the vehicle 100 may transfer control right to the occupant.

The above description with reference to FIG. 3 and FIG. 4 has been illustrated by assuming that the vehicle and/or surrounding state changes sequentially in the order of the undetected state, the detected state, the approaching state, the adjacent state, and the departure state. However, a change in the vehicle and/or surrounding state according to the present disclosure is not limited by the content illustrated in FIG. 3 and FIG. 4. The vehicle and/or surrounding state may change in an order different from that of FIG. 3 and FIG. 4. For example, assuming a case where the sinkhole suddenly occurs and both passage and driving itself become impossible, the vehicle and/or surrounding state is immediately changed from the undetected state to the departure state.

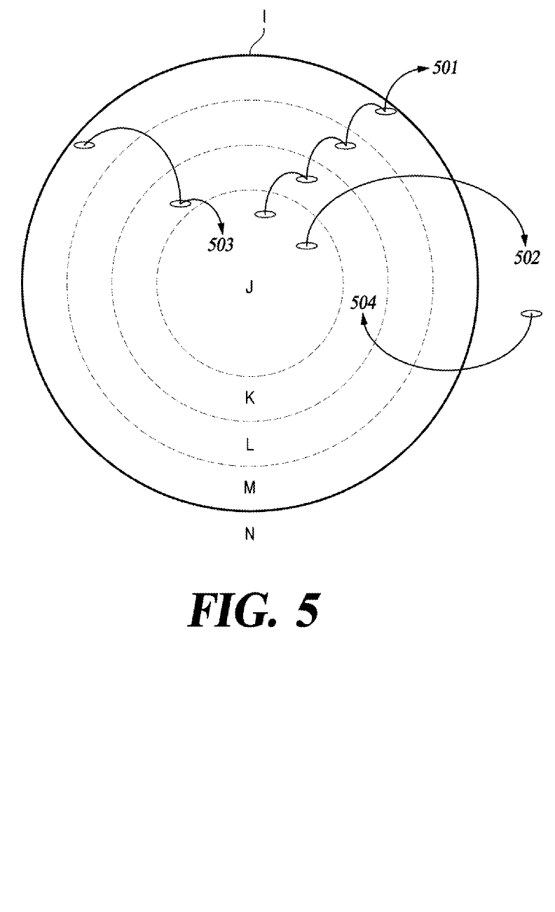

FIG. 5 is a schematic diagram of an example operational design domain.

In FIG. 5, the inner side of the boundary I of operational design domain is in a non-departure state, and the outer side of the boundary I of operational design domain is in a departure state. In FIG. 5, the region J indicates the undetected state, the region K indicates the detected state, the region L indicates the approaching state, the region M indicates the adjacent state, and the region N indicates the departure state.

Even when there is no malfunction in the autonomous driving function of the vehicle 100, the operational design domain may not be satisfied if there is a problem in an external environment condition (e.g., weather condition, traffic environment condition, or the like). When the vehicle is in a departure state in which the operational design domain is not satisfied, autonomous driving is not possible.

That is, whether the operational design domain is satisfied should be determined by considering not only the vehicle 100 but also a surrounding environment of the vehicle 100. Accordingly, when determining whether autonomous driving is possible, the processor 130 comprehensively reviews and determines the state of the vehicle 100 and the surrounding environment of the vehicle 100 (hereinafter, “vehicle and/or surrounding state”).

The processor 130 determines the vehicle and/or surrounding state as the undetected state, the detected state, the approaching state, the adjacent state, or the departure state for the boundary of operational design domain. Depending on which state the vehicle and/or surrounding state is determined to correspond to, the processor 130 performs guidance operation differently to the occupant. The higher the possibility that the vehicle and/or surrounding state will depart from the boundary of operational design domain, the more specific and detailed the guidance performed by the processor 130 becomes. That is, when the vehicle and/or surrounding state corresponds to the region K, the processor 130 provides high-level attribute information; when it corresponds to the region L, the processor provides unit attribute information; and when it corresponds to the region M, the processor provides unit numerical information. When the vehicle and/or surrounding state corresponds to the region N, the processor 130 changes the autonomous driving mode to the fallback mode.

The pattern of changes in the vehicle and/or surrounding state may occur in a variety of ways.

For example, a first change 501 illustrated in FIG. 5 represents that the vehicle and/or surrounding state changes in the order of the undetected state, the detected state, the approaching state, the adjacent state, and the departure state.

For example, a second change 502 illustrated in FIG. 5 represents that the vehicle and/or surrounding state changes from the undetected state to the departure state at once.

For example, a third change 503 illustrated in FIG. 5 represents that the vehicle and/or surrounding state changes from the adjacent state to the detected state at once, and then from the detected state to the undetected state.

For example, a fourth change 504 illustrated in FIG. 5 represents that the vehicle and/or surrounding state changes from the departure state to the detected state at once.

The change in the vehicle and/or surrounding state is not limited by the examples described above. In addition to the first change 501 to the fourth change 504, the vehicle and/or surrounding state may change in various patterns.

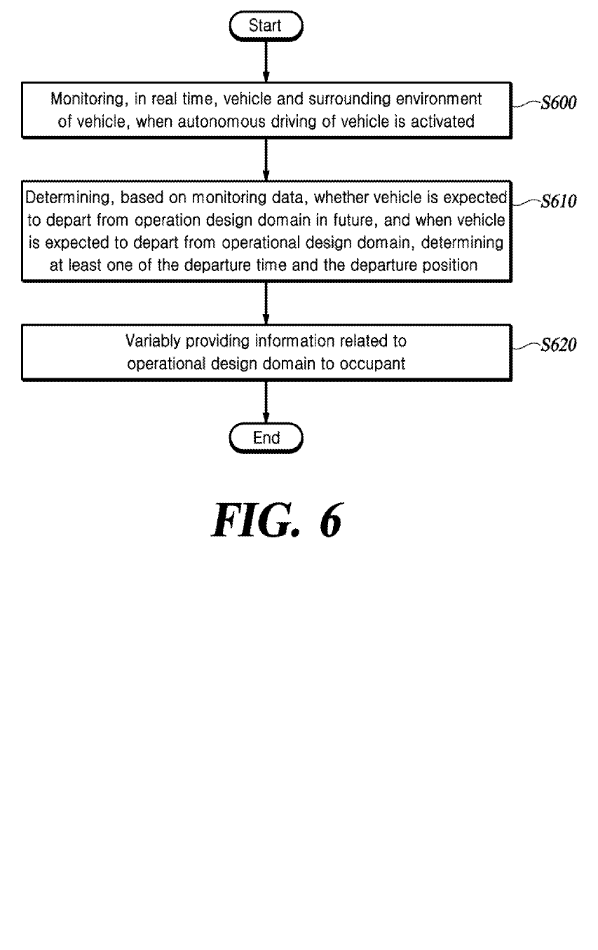

FIG. 6 is a flowchart illustrating an example method of controlling a vehicle when departure from the operational design domain is expected.

Referring to FIG. 6, when autonomous driving is activated, the vehicle 100 may monitor, in real time, the vehicle and the surrounding environment of the vehicle (S600). Based on the monitoring data collected by the monitoring, the processor 130 may determine, in real time, the vehicle and/or surrounding state.

The vehicle 100 may determine, based on the monitoring data whether the vehicle 100 is expected to depart from the operational design domain in the future (e.g., before a reference time, such as within 10 seconds), and when the vehicle 100 is expected to depart from the operational design domain, determine at least one of the departure time and the departure position (S610).

The vehicle 100 may variably provide information related to the operational design domain to the occupant (S620). For example, the vehicle 100 may variably provide the information related to the operational design domain according to whether the vehicle is expected to depart from the operational design domain in the future (e.g., before a reference time, such as within 10 seconds), the departure time, and the departure position.

If it is determined that the vehicle 100 is expected to depart from the operational design domain, if the departure time is at least a first threshold time duration after a current time (e.g., if the departure time is later than a reference time), or if the departure position is equal to or greater than the first threshold distance from the current position of the vehicle, the vehicle 100 may provide first operational design domain information. The first operational design domain information may include information on a cause of departure from the operational design domain and a state of the autonomous driving system at the time of departure. The first operational design domain information may refer to a concept corresponding to the high-level attribute information described above. The information on the state of the autonomous driving system may include sensor-related information and sensor recognition-related information, vehicle control-related information, autonomous driving mode-related information, communication system-related information, surrounding environment information, or the like. The sensor-related information and sensor recognition-related information may include, for example, information such as whether the sensor is operating normally, whether the object may be detected, the accuracy of distance detection, and whether the signal strength is appropriate. The vehicle control-related information may include, for example, information such as a current speed and acceleration state of the vehicle, a steering angle state, whether the brake operates normally, a wear state of the brake pad, longitudinal control, lateral control, a current posture of the vehicle, and whether posture control is being performed. The autonomous driving mode-related information may include, for example, information such as a level of autonomous driving currently being performed, whether the operational design domain is satisfied, and a possibility of departure from the operational design domain. The communication system-related information may include, for example, information such as a signal strength and connection state of Vehicle-to-Everything (V2X) communication. The information on the state of the autonomous driving system is not limited by the examples described above. The surrounding environment information may include information such as weather, road conditions, and objects around the vehicle.

If it is determined that the vehicle 100 is expected to depart from the operational design domain, the vehicle 100 may provide second operational design domain information, if any one of the following conditions is satisfied: the departure time being less than the first threshold time from the current time; the departure position being less than the first threshold distance from the current position of the vehicle; a second threshold time having elapsed since the first operational design domain information was provided; and a second threshold distance having been traveled since the first operational design domain information was provided. The second operational design domain information may include state information on a sub-function or component of the autonomous driving system at the time of departure from the operational design domain. The second operational design domain information may refer to a concept corresponding to the unit attribute information described above. The second operational design domain information may be information obtained by further adding technical terms and/or technical evaluations to the first operational design domain information. The state information on the sub-function or component of the autonomous driving system may be information obtained by further adding technical terms and/or technical evaluations to the state information of the autonomous driving system described above. The second threshold distance may be shorter than the first threshold distance, and the second threshold time may be a shorter time than the first threshold time.

If it is determined that the vehicle 100 is expected to depart from the operational design domain, the vehicle 100 may provide third operational design domain information, if any one of the following conditions is satisfied: the departure time being less than the third threshold time from the current time; the departure position being less than the third threshold distance from the current position of the vehicle; a fourth threshold time having elapsed since the second operational design domain information was provided; and a fourth threshold distance having been traveled since the second operational design domain information was provided. The third operational design domain information may include at least one of the cause of departure from the operational design domain, numerical information on the cause of departure, and numerical information on a state of the autonomous driving system at the time of departure from the operational design domain. The third operational design domain information may refer to a concept corresponding to the unit numerical information described above. The third operational design domain information may be information obtained by further adding numerical information to the second operational design domain information. The third threshold time may be shorter than the first threshold time. The third threshold distance may be shorter than the first threshold distance. The fourth threshold time may be shorter than the first threshold time. The fourth threshold distance may be shorter than the first threshold distance.

If the vehicle 100 has departed from the operational design domain and the occupant does not perform the dynamic driving task (e.g., the vehicle does not detect the dynamic driving task within a threshold time duration after the vehicle departs from the operational design domain), the vehicle 100 may be stopped by the minimal risk maneuver.

If it is determined that the vehicle 100 has departed from the operational design domain, the processor 130 may transfer the vehicle control right from the vehicle 100 to the occupant.

If the vehicle 100 transitions from the departure state to the non-departure state with respect to the operational design domain, the processor 130 may reactivate autonomous driving of the vehicle 100.

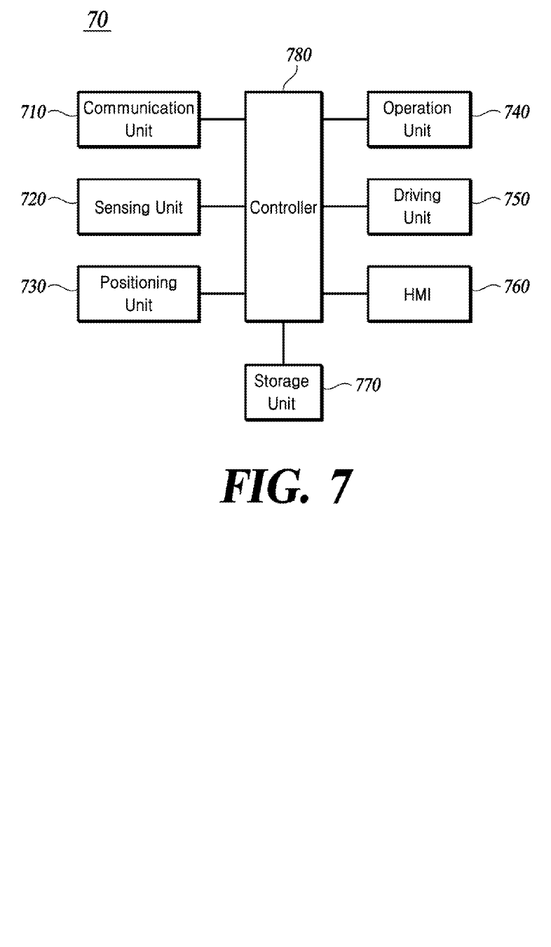

FIG. 7 is a block diagram schematically illustrating an example vehicle system.

Referring to FIG. 7, the vehicle 70 includes at least one of a communication unit 710, a sensing unit 720, a positioning unit 730, an operation unit 740, a driving unit 750, an HMI 760, a storage unit 770, and a controller 780. The vehicle 70 illustrated in FIG. 7 may be treated the same as the vehicle 100 described in FIG. 1 to FIG. 6.

The communication unit 710 may exchange signals with devices located outside and inside the vehicle 70. The communication unit 710 may exchange signals with at least one of an infrastructure device such as a server or a base station, another vehicle, and a terminal. The communication unit 710 may include at least one of a transmission antenna, a reception antenna, a Radio Frequency (RF) circuit capable of implementing various communication protocols, and an RF element, in order to perform communication. The communication unit 710 may include an internal communication unit and an external communication unit. The internal communication unit may transmit or receive using various communication protocols present in the vehicle 70. The internal communication protocol may include at least one of a controller area network (CAN), a CAN with Flexible Data rate (CAN FD), an ethernet, a Local Interconnect Network (LIN), and a FlexRay. The communication protocol may include other protocols for communication between various devices mounted in the vehicle. The external communication unit may communicate with other vehicles, infrastructure systems, base stations, roadside devices, and the like using various communication protocols. The external communication protocol may include vehicle-to-everything (V2X) communication including vehicle-to-vehicle (V2V) communication, vehicle-to-infrastructure (V2I) communication, vehicle-to-network (V2N) communication, and vehicle-to-pedestrian (V2N) communication. The infrastructure may be, for example, a roadside unit or a server that periodically sends out traffic information in conjunction with a Transportation Information System (TIS), an Intelligent Transport System (ITS), or the like.

The sensing unit 720 may sense the state of the vehicle 70 and an external object.

The sensing unit 720 may include at least one of an inertial measurement unit (IMU), a distance measuring instrument (DMI) device, a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, and a pedal position sensor, in order to sense the state of the vehicle 70. The inertial measurement unit (IMU) sensor may include one or more of an acceleration sensor, a gyro sensor, and a magnetic sensor. The sensing unit 720 may generate state data of the vehicle based on signals generated from at least one sensor. For example, direction information such as a heading and a yaw rate of the vehicle 70 may be collected by the sensing unit 720.

The sensing unit 720 may include at least one of the camera, the radar sensor, the light detection and ranging (LiDAR) sensor, the ultrasonic sensor, and the infrared sensor, in order to sense the external object. The sensing unit 720 may measure at least one of information on the presence or absence of the object, position information of the object, distance information between the vehicle 70 and the object, and relative speed information between the vehicle 70 and the object.

The positioning unit 730 may generate position data of the vehicle 70. The positioning unit 730 may include at least one of GPS, DGPS, or GNSS. The positioning unit 730 may generate position data of the vehicle 70 based on signals generated from at least one of GPS, DGPS, or GNSS. The positioning unit 730 may estimate the position of the vehicle 70 based on the wireless signals received from the communication unit 710. The positioning unit 730 may estimate the current position of the vehicle 70 based on the previous position, the travel distance information, the travel time information, the speed information, or the acceleration information of the vehicle 70 by using the IMU or the DMI. Based on the position information of the vehicle 70 collected by the positioning unit 730, the controller 780 may estimate a path history and a path prediction of the vehicle 70.

The operation unit 740 receives user input for driving. In a manual mode, the vehicle 70 may be operated based on signals provided by the operation unit 740. The operation portion 740 may include a steering input device such as steering wheel, an acceleration input device such as accelerator pedal, and a brake input device such as brake pedal.

The driving unit 750 is a device that electrically controls various vehicle driving devices in the vehicle 70. The drive unit 750 may include power train driving control devices, chassis driving control devices, door/window driving control devices, safety device driving control devices, lamp driving control devices, and air conditioning driving control devices. The driving unit 750 controls the movement of the vehicle 70 based on an input signal from the operation unit 740 or a control signal from the controller 780.

The HMI 760 is a device for communication between the vehicle 70 and the person (e.g., the occupant of the vehicle 70 or other vehicle(s)). The HMI 760 may receive input from a user and provide the user with information generated in the vehicle 70. The vehicle 70 may implement a user interface (UI) or a user experience (UX) through the HMI 760. The HMI 760 may include an input device such as touch panel, microphone, or the like, and may include an output device such as display device, speaker, or the like. For example, the HMI 760 may include an internal display that outputs a screen toward the vehicle interior and/or an external display that outputs the screen toward the vehicle exterior.

The storage unit 770 may store a program that causes the controller 780 to perform a method according to the present disclosure. For example, the program may include a plurality of instructions executable by the processor, and the plurality of instructions may be executed by the processor to perform a method according to the present disclosure.

The storage unit 770 may be a single memory or a plurality of memories. When the storage unit 770 is composed of the plurality of memories, the plurality of memories may be physically separated. The storage unit 770 may include at least one of volatile memory and non-volatile memory. The volatile memory includes a static random access memory (SRAM), a dynamic random access memory (DRAM), or the like, and the nonvolatile memory includes a flash memory or the like.

The storage unit 770 stores map information. The map information may be any one of a navigation map and/or a high definition map (HD map). The high definition map may be received from the external device, or pre-stored. The navigation map may include geographic information, road information, lane information, building information, signal information, or the like. The high definition map includes more specific data relative to the navigation map. The high definition map may include, in a road unit, road inclination, road curvature, sign information, or the like. The high definition map may include, in a lane unit, lane information, lane boundary information, stop line position, traffic light position, signal sequence, intersection information, or the like. The high definition map may include basic road information, surrounding environment information, detailed road environment information, or dynamic road condition information. The detailed road environment information may include static information such as terrain elevation, curvature, line, lane centerline, regulation line, road boundary, road centerline, traffic sign, road surface sign, shape and height of road, and width of lane. The dynamic road condition information may include traffic congestion, accident zones, construction zones, or the like. The high definition map may include road surrounding environment information implemented in 3D, geometric information such as road shape or facility structure, and semantic information such as traffic indication or line marking.

The controller 780 may include at least one core capable of executing at least one instruction. The controller 780 may execute instructions stored in the storage unit 770. The controller 780 may be a single processor or a plurality of processors.

Each component of the apparatus or method according to the present disclosure may be implemented in hardware or software, or may be implemented in a combination of hardware and software. In addition, the function of each component may be implemented in software, and a microprocessor may be implemented to execute the function of the software corresponding to each component.

Various implementations of the systems and techniques described herein may be realized in digital electronic circuits, integrated circuits, field programmable gate arrays (FPGAs), application specific integrated circuits (ASICs), computer hardware, firmware, software, and/or combinations thereof. These various implementations may include implementations in one or more computer programs executable on a programmable system. The programmable system includes at least one programmable processor (which may be a special-purpose processor or may be a general-purpose processor) coupled to receive data and instructions from, and to transmit data and instructions to, a storage system, at least one input device, and at least one output device. The computer programs (also known as programs, software, software applications or code) include instructions for a programmable processor and are stored on a “computer-readable recording medium.”

The computer-readable recording medium includes all kinds of recording devices in which data readable by a computer system is stored. Such a computer-readable recording medium may be a non-volatile or non-transitory medium such as a read-only memory (ROM), a compact disc ROM (CD-ROM), a magnetic tape, a floppy disk, a memory card, a hard disk, a magneto-optical disk, or a storage device, and may further include a transitory medium such as a data transmission medium. In addition, the computer-readable recording medium may be distributed in a network-connected computer system, and the computer-readable code may be stored and executed in a distributed manner.

Although each process is described as being executed sequentially in the flowchart/timing diagram of the present disclosure, this is merely an illustrative explanation of the technical idea of the present disclosure. In other words, the flowcharts/timing diagrams are not limited to a chronological order, as those of ordinary skill in the art may make various modifications and variations to the flowchart/timing diagram by changing the order described or by executing one or more processes in parallel without departing from the essential characteristics of the present disclosure.

The above description is merely illustrative of the technical idea of the present disclosure, and various modifications and variations may be made by those skilled in the art to which the present disclosure pertains without departing from the essential characteristics of the present disclosure. Therefore, the one or more example embodiments are not intended to limit the technical idea of the present disclosure, but are intended to be illustrative, and the scope of the technical idea of the present disclosure is not limited by these example embodiment(s). The protection scope of the present disclosure should be construed according to the following claims, and all technical ideas within the scope equivalent thereto are construed as being included in the scope of rights of the present disclosure.

Each component of the apparatus or method according to the present disclosure may be implemented in hardware or software, or may be implemented in a combination of hardware and software. In addition, the function of each component may be implemented in software, and a microprocessor may be implemented to execute the function of the software corresponding to each component.

Various implementations of the systems and techniques described herein may be realized in digital electronic circuits, integrated circuits, field programmable gate arrays (FPGAs), application specific integrated circuits (ASICs), computer hardware, firmware, software, and/or combinations thereof. These various implementations may include implementations in one or more computer programs executable on a programmable system. The programmable system includes at least one programmable processor (which may be a special-purpose processor or may be a general-purpose processor) coupled to receive data and instructions from, and to transmit data and instructions to, a storage system, at least one input device, and at least one output device. The computer programs (also known as programs, software, software applications or code) include instructions for a programmable processor and are stored on a “computer-readable recording medium.”

The computer-readable recording medium includes all kinds of recording devices in which data readable by a computer system is stored. Such a computer-readable recording medium may be a non-volatile or non-transitory medium such as a ROM, a CD-ROM, a magnetic tape, a floppy disk, a memory card, a hard disk, a magneto-optical disk, or a storage device, and may further include a transitory medium such as a data transmission medium. In addition, the computer-readable recording medium may be distributed in a network-connected computer system, and the computer-readable code may be stored and executed in a distributed manner.

Although each process is described as being executed sequentially in the flowchart/timing diagram of the present disclosure, this is merely an illustrative explanation of the technical idea of the present disclosure. In other words, the flowcharts/timing diagrams are not limited to a chronological order, as those of ordinary skill in the art may make various modifications and variations to the flowchart/timing diagram by changing the order described or by executing one or more processes in parallel without departing from the essential characteristics of the present disclosure.

An aspect of the disclosure is to provide a method of controlling a vehicle, the method including: monitoring, in real time, the vehicle and a surrounding environment of the vehicle, when autonomous driving of the vehicle is activated; determining, based on monitoring data, whether the vehicle is expected to depart from an operation design domain in the future, and when it is determined that the vehicle is expected to depart therefrom, determining at least one of a departure time point and a departure position; and providing an occupant with information regarding the operation design domain related to the autonomous driving of the vehicle.

An aspect of the disclosure is to provide a method of controlling a vehicle configured to perform autonomous driving, the method including: monitoring, in real time, the vehicle and a surrounding environment of the vehicle, when autonomous driving of the vehicle is activated; determining, in real time, a state of the vehicle and/or the surrounding environment of the vehicle based on monitoring data; variably performing a guidance operation to an occupant according to the state; and variably setting a mode of the autonomous driving according to the state, wherein the state is any one of an undetected state, a detected state, an approaching state, an adjacent state, and a departure state for a boundary of operation design domain.

The performing the guidance operation when the state is the detected state includes providing high-level attribute information of the operation design domain; the performing the guidance operation when the state is the approaching state includes providing unit attribute information of the operation design domain; and the performing the guidance operation when the state is the adjacent state includes providing unit numerical information of the operation design domain.

The providing the high-level attribute information includes providing at least one or more of: whether longitudinal behavior control among the functions of the autonomous driving is possible; whether lateral behavior control is possible; whether lane change control is possible; whether a transfer of vehicle control right is required; and whether a change of the mode is required.

The providing the unit attribute information includes providing at least one or more of a static road environment factor, a dynamic road environment factor, a driving environment factor, and whether the functions of the vehicle are operating normally.

The providing the unit numerical information includes providing at least one or more of a line recognition error rate, a remaining distance to a highway exit, a time point for transfer of the vehicle control right, and an error rate of the lateral behavior control.

Then the state is the departure state, the setting of the autonomous driving mode includes setting the autonomous driving mode to a fallback mode.

The fallback mode includes a process in which the vehicle performs a minimal risk maneuver.

The fallback mode includes a process in which vehicle control right is transferred from the vehicle to the occupant.

The method may further include reactivating the autonomous driving when the state changes from the departure state to any one of the detected state, the approaching state, and the adjacent state.

An aspect of the disclosure is to provide a vehicle configured to perform autonomous driving, including: a sensor unit configured to monitor, in real time, the vehicle and a surrounding environment of the vehicle to generate monitoring data; and a processor configured to, when the autonomous driving is activated, determine, in real time, a state of the vehicle and the environment around the vehicle based on the monitoring data, variably perform a guidance operation to an occupant according to the state, and variably control a mode of the autonomous driving according to the state, wherein the state is any one of a detected state, an approaching state, an adjacent state, and a departure state for a boundary of operation design domain.

The above description is merely illustrative of the technical idea of the present disclosure, and various modifications and variations may be made by those skilled in the art to which the present disclosure pertains without departing from the essential characteristics of the present disclosure. Therefore, the example embodiment(s) are not intended to limit the technical idea of the present disclosure, but are intended to be illustrative, and the scope of the technical idea of the present disclosure is not limited by these example embodiment(s). The protection scope of the present disclosure should be construed according to the following claims, and all technical ideas within the scope equivalent thereto are construed as being included in the scope of rights of the present disclosure.

1. A method performed by an apparatus of a vehicle, the method comprising:
monitoring, based on an autonomous driving feature of the vehicle being activated, a state of the vehicle and a surrounding environment of the vehicle;
determining, based on the state of the vehicle and the surrounding environment, whether the vehicle is expected to depart from an operational design domain associated with the autonomous driving feature; and
based on determining that the vehicle is expected to depart from the operational design domain, determining information about the operational design domain, wherein the information comprises at least one of:
a departure time at which the vehicle is expected to depart from the operational design domain, or
a departure position at which the vehicle is expected to depart from the operational design domain; and
outputting, via a user interface of the vehicle, the information.

2. The method of claim 1, wherein the outputting of the information comprises:
based on whether the vehicle is expected to depart from the operational design domain, the departure time, and the departure position, outputting different pieces of information associated with the expected departure from the operational design domain.

3. The method of claim 1, wherein the outputting of the information comprises:
based on the vehicle being expected to depart from the operational design domain and the departure time being at least a first threshold time duration after a current time or based on the departure position being at least a first threshold distance away from a current position of the vehicle, outputting first operational design domain information comprising a cause of departure from the operational design domain and a state of the autonomous driving feature at the departure time.

4. The method of claim 3, wherein the outputting of the information further comprises:
outputting second operational design domain information, based on the vehicle being expected to depart from the operational design domain and based on at least one of:
the departure time being within the first threshold time duration from the current time;
the departure position being within the first threshold distance from the current position of the vehicle;
a second threshold time duration having elapsed since the outputting of the first operational design domain information; or
a second threshold distance being traveled by the vehicle since the outputting of the first operational design domain information,
wherein the second operational design domain information comprises state information, at the departure time, of a sub function or a component associated with the autonomous driving feature,
wherein the second threshold distance is less than the first threshold distance, and
wherein the second threshold time duration is less than the first threshold time duration.

5. The method of claim 4, wherein the outputting of the information further comprises:
outputting third operational design domain information, based on the vehicle being expected to depart from the operational design domain and based on at least one of:
the departure time being within a third threshold time duration from the current time;
the departure position being within a third threshold distance from the current position of the vehicle;
a fourth threshold time duration having elapsed since the outputting of the second operational design domain information; or
a fourth threshold distance being traveled by the vehicle since the outputting of the second operational design domain information, and
wherein the third operational design domain information comprises at least one of: the cause of departure from the operational design domain, numerical information regarding the cause of departure, and numerical information regarding the state of the autonomous driving feature at the departure time.

6. The method of claim 1, further comprising:
performing, based on a dynamic driving task (DDT) not being detected within a threshold time duration after the vehicle departs from the operational design domain, a minimal risk maneuver (MRM) to stop the vehicle.

7. The method of claim 1, further comprising:
transferring, based on the vehicle being expected to depart from the operational design domain, vehicle control from the vehicle to an occupant of the vehicle.

8. The method of claim 1, further comprising:
reactivating, based on the vehicle entering the operational design domain, the autonomous driving feature.

9. The method of claim 1, further comprising:
determining, based on sensing data of at least one sensor of the vehicle, the state of the vehicle and the surrounding environment of the vehicle; and
identifying at least one event, associated with an expected departure from the operational design domain, that is expected to occur within a predetermined time period from a reference time,
wherein the determining of whether the vehicle is expected to depart from the operational design domain is further based on map data associated with a driving path of the vehicle.

10. A vehicle comprising:
a human-machine interface (HMI) configured to output at least one of a visual signal, a tactile signal, or an auditory signal to provide information to an occupant of the vehicle;
a sensor configured to monitor, based on an autonomous driving feature of the vehicle being activated, a state of the vehicle and a surrounding environment of the vehicle;
a processor; and
a memory storing at least one instruction that is configured, when executed by the processor communicating with the memory, to cause the vehicle to:
determine, based on the state of the vehicle and the surrounding environment, whether the vehicle is expected to depart from an operational design domain associated with the autonomous driving feature; and
based on determining that the vehicle is expected to depart from the operational design domain, determine information about the operational design domain, wherein the information comprises at least one of:
a departure time at which the vehicle is expected to depart from the operational design domain, or
a departure position at which the vehicle is expected to depart from the operational design domain; and
output, via the HMI, the information.

11. The vehicle of claim 10, wherein the at least one instruction is configured, when executed by the processor communicating with the memory, to cause the vehicle to output the information by:
based on whether the vehicle is expected to depart from the operational design domain, the departure time, and the departure position, output, via the HMI, different pieces of information associated with the expected departure from the operational design domain.

12. The vehicle of claim 10, wherein the at least one instruction is configured, when executed by the processor communicating with the memory, to cause the vehicle to output the information by:
based on the vehicle being expected to depart from the operational design domain and the departure time being at least a first threshold time duration after a current time or based on the departure position being at least a first threshold distance away from a current position of the vehicle, outputting first operational design domain information comprising a cause of departure from the operational design domain and a state of the autonomous driving feature at the departure time.

13. The vehicle of claim 12, wherein the at least one instruction is configured, when executed by the processor communicating with the memory, to cause the vehicle to output the information further by:
outputting second operational design domain information, based on the vehicle being expected to depart from the operational design domain and based on at least one of:
the departure time being within the first threshold time duration from the current time;
the departure position being within the first threshold distance from the current position of the vehicle;
a second threshold time duration having elapsed since the outputting of the first operational design domain information; or
a second threshold distance being traveled by the vehicle since the outputting of the first operational design domain information,
wherein the second operational design domain information comprises state information, at the departure time, of a sub function or a component associated with the autonomous driving feature,
wherein the second threshold distance is less than the first threshold distance, and
wherein the second threshold time duration is less than the first threshold time duration.

14. The vehicle of claim 13, wherein the at least one instruction is configured, when executed by the processor communicating with the memory, to cause the vehicle to output the information further by:
outputting third operational design domain information, based on the vehicle being expected to depart from the operational design domain and based on at least one of:
the departure time being within a third threshold time duration from the current time;
the departure position being within a third threshold distance from the current position of the vehicle;
a fourth threshold time duration having elapsed since the outputting of the second operational design domain information; or
a fourth threshold distance being traveled by the vehicle since the outputting of the second operational design domain information, and
wherein the third operational design domain information comprises at least one of: the cause of departure from the operational design domain, numerical information regarding the cause of departure, and numerical information regarding the state of the autonomous driving feature at the departure time.

15. The vehicle of claim 10, wherein the at least one instruction is configured, when executed by the processor communicating with the memory, to further cause the vehicle to:
perform, based on a dynamic driving task (DDT) not being detected within a threshold time duration after the vehicle departs from the operational design domain, a minimal risk maneuver (MRM) to stop the vehicle.

16. The vehicle of claim 10, wherein the at least one instruction is configured, when executed by the processor communicating with the memory, to further cause the vehicle to:
transfer, based on the vehicle being expected to depart from the operational design domain, vehicle control from the vehicle to the occupant.

17. The vehicle of claim 10, wherein the at least one instruction is configured, when executed by the processor communicating with the memory, to further cause the vehicle to:
reactivate, based on the vehicle entering the operational design domain, the autonomous driving feature.

18. The vehicle of claim 10, wherein the at least one instruction is configured, when executed by the processor communicating with the memory, to further cause the vehicle to:
determine, based on sensing data of at least one sensor of the vehicle, the state of the vehicle and the surrounding environment of the vehicle;
identify at least one event, associated with an expected departure from the operational design domain, that is expected to occur within a predetermined time period from a reference time; and
determine that the vehicle is expected to depart from the operational design domain based on:
map data associated with a driving path of the vehicle,
the state of the vehicle, and
the surrounding environment.
